(19) United States
(12) Patent Application Publication
(10) Pub. No.: US 2012/0276302 A1
(43) Pub. Date: Nov. 1, 2012

(54) Process for Treating Wood

(76) Inventors: Kell Thomas, Frederiksberg (DK); Henrik Groenfeldt Mortensen, Graested (DK); Claus Ludvig Engelbrecht Holm, Graested (DK)

(21) Appl. No.: 13/508,833

(22) PCT Filed: Nov. 20, 2009
(86) PCT No.: PCT/IB2009/055224

§ 371 Date: Jul. 16, 2012

(51) Int. Cl. B05D 7/06; B05C 3/02; B05D 3/02

(52) U.S. Cl. 427/543; 118/620

(57) ABSTRACT

A method for treating wood by a treatment liquid is put forward. The method comprising the steps of: providing a container to hold the wood and the treatment liquid, placing the wood m the container, providing a electrode in the container for subjecting the wood to radio-emission, and providing a specific volume of the treatment liquid Ln the container for at least partially covering the wood and to at feast partially covering the electrode below the surface of the treatment liquid. Further, the method comprises the steps of providing a first flow in the container of the treatment liquid towards and from the wood at feast partially covered by the treatment liquid for removing at least some of the treatment liquid at the wood, and subjecting the wood at teas! partially covered by the treatment liquid to an exposure by radio-emission from the electrode for Increasing the temperature of the wood.

### TECHNICAL FIELD OF THE INVENTION

A method for fluid treatment of wood is put forward involving a simultaneous heating of the wood.

### BACKGROUND OF THE INVENTION (PRIOR ART)

In the wood industry, it is common that the wood is treated to obtain certain attributes or features, e.g. resistance to microorganisms, lower contents of natural fluids, altered structural properties or a particular colour. However, a common and costly problem within wood treatment is warping of the wood, which is explained by two principal effects. Firstly, the warping may be a result of shrinkage anisotropy, resulting in cupping, bowing, and twisting. Secondly, the warping may be a result of uneven drying, leading to structural damage, such as raptures, external and internal checks, and splits

One common step in wood treatment involves heating of a wooden product, which can be achieved by applying different forms of electromagnetic radiation. At the shortest wavelengths, the product is illuminated by infrared radiation, where the heat reaches the interior of the product through convection or conduction from the surface. Microwave radiation can also be applied for heating, where the temperature is increased through direct dielectric heating of the product. This gives a deeper penetration of the applied energy. At the longest wavelengths, the product can be subjected to high-frequency radio emission, which also increases the temperature through dielectric heating, but with a deeper penetration compared with that of microwave radiation, thereby enabling a more homogeneous heating.

Another common step within wood treatment involves impregnation with a fluid, e.g. a preservative, in a high-pressure environment. Here, a method is put forward allowing a comparatively large amount of fluid to be added to the structure of the wood by combining steps of heating by electromagnetic radiation, vacuum treatment, and high-pressure treatment.

### OBJECTS OF THE INVENTION

An object according to the present invention is to provide a method for adding a treatment liquid to the internal structure of wood. A particular feature of the present invention is that the temperature of the wood is increased through dielectric heating by exposure to radio emission while the wood is immersed in the treatment liquid. This allows for the treatment liquid to be added to wood that has a high water contents without first drying the wood. Another feature of the present invention is that the treatment liquid is made to flow past the wood. One advantage with this feature is that the flow removes natural liquids expelled from the wood from the vicinity of the wood, which prevents them from being reabsorbed in the wood.

### SUMMARY/DISCLOSURE OF THE INVENTION

In addition to the above object, the above advantages and the above features, numerous other objects, advantages and features will be evident from the general and detailed descriptions given below of preferred embodiments according to the present invention. The objects, advantages and features are according to a first aspect of the present invention obtained by a method for treating wood by a treatment liquid comprising the steps of providing a container to hold the wood and the treatment liquid, placing the wood in the container, providing an electrode in the container for subjecting the wood to radio-emission, providing a specific volume of the treatment liquid in the container for at least partially covering the wood and to at least partially covering the electrode below the surface of the treatment liquid, providing a first flow in the container of the treatment liquid towards and from the wood at least partially covered by the treatment liquid for removing at least some of the treatment liquid at the wood, and subjecting the wood at least partially covered by the treatment liquid to an exposure by radio-emission from the electrode for increasing the temperature of the wood.

Fluids present in the wood prior to the treatment, e.g. fluids natural to the wood or water impregnated through after a period under water, will be expelled from within the wood when temperature is increased. The treatment liquid will at the same time penetrate into the structure of the wood, without any drying of the wood in the process. This means that deformations caused by drying are avoided and the wood better maintains its original shape when being processed.

The wood may be unseasoned or seasoned. Further, the wood may have been impregnated with a first liquid prior to being subjected to the treatment, which to some extent is replaced by the treatment liquid. The first liquid may be another treatment liquid. Further, the wood may be from an archaeological finding in a wet environment, e,g. from a marine site whereby the first liquid is mainly water.

The wood may be a single piece of wood, such as a log. The wood may constitute a plurality of pieces of wood, e g. baulks, planks or boards, heartwood or sapwood boards, trimmed or untrimmed boards, slabs or outside boards, half or quarter timber, and/or boards with a wane. The wood may also be a composite wooden product from a plurality of pieces of wood, such as laminated wood or a wooden chair.

The heating of the wood may have the advantage that the liquid within the wood is heated, whereby the viscosity of the liquid decreases, and the liquid can penetrate even further into the wood structure. The subsequent heating may also increase the internal pressure in the wood, which may force the liquid into cavities it has not reached.

The treatment fluid may be a preservation fluid, a colorant, or a particular chemical compound or mix of chemical compounds As an example, the treatment liquid may be a 20% solution of dinatriumoctaborat-tetraborat in monoetylenglycol, or it may be a linseed oil based paint. Alternatively, the treatment liquid may he liquid water, supplied for increasing the water contents of the wood.

The container may be an open container so that the wood and the treatment liquid in the container are at the same pressure as the ambient atmosphere, thereby reducing pressure variations of the wood when the treatment liquid and/or structural damage to the wood that could otherwise follow. Further, the container may be open to allow a ventilation of the surface of treatment liquid to be ventilated, where the ventilation may be for providing a cooling of the treatment liquid. The container may have walls and a bottom approximating a rectangular cuboid, where the upper side is completely open.

The electrode may be flexible metal-band electrodes that can be formed to fit an irregularly shaped piece of wood. The metal band electrodes may be covered by a non-conducting layer to prevent electrical currents to leak from the electrodes to the treatment liquid. The heating is primarily obtained via dielectric heating, i.e. the frequency or frequencies of the radio-emission may be chosen to achieve the highest amount of absorbed power in the whole volume of the wood under treatment.

The specific volume of the treatment liquid may be defined by determining what parts of the wood that are to be immersed, and then adding the treatment liquid to the container until these parts are covered. Then, the added amount of treatment liquid corresponds to the specific volume of treatment liquid.

The first flow towards and from the wood moves particles and fluids expelled from the wood away from the wood. This means that the expelled particles or fluids cannot be reabsorbed in the wood. Instead, treatment liquid is absorbed into the structure of the wood, which increases the rate of impregnation.

The step of providing a first flow in the container may further comprise: providing an outlet for the treatment liquid in the container, providing an inlet for the treatment liquid in the container, interconnecting the outlet and the inlet for leading the treatment liquid there between, providing a circulation flow of the treatment liquid in the container out through the outlet and via the conduit back to the container through the inlet. This allows for an efficient cooling of the wood. The outlet and/or the inlet may have an adjustable position relative to the container. This way, wood of different sizes and shapes may be placed in the container and the outlet and/or the inlet may be positioned for obtaining an optimal first flow for each shape or size. For example, the inlet and outlet may be position at opposite ends of a log resting in a horizontal position, thereby providing a flow along the complete length of the log. In another example, the inlet may be positioned inside a stack of boards, while the outlet is positioned outside the same stack, thereby allowing for a first flow outwards from the centre of the wood.

The step of providing a first flow in the container may further comprise: positioning the outlet and the inlet on opposite sides of the wood. This is particularly favorable for the case of wood defining an elongated shape, in which case the inlet is positioned at one short end, while the outlet is positioned at the other short-end. The step of providing a first flow in the container may further comprise: positioning the inlet at the bottom of the container. As the wood is heated it may give rise to a vertical convective flow in the container. Thereby, by introducing the first flow at the bottom of the convective flow, an efficient cooling of the wood can be obtained.

The method for treating wood according to the first aspect of the present invention may further comprise the step of: positioning the electrode distant from the wood for allowing the first flow to pass between the wood and the electrode. This allows for an efficient cooling, of the parts of the wood closest to the electrode.

The wood may comprise a plurality of pieces of wood and the method for treating wood according to the first aspect of the present invention may further comprise the step of: positioning the pieces of wood distant from one another for allowing the first flow to pass between them. This has the advantage that also large volumes of several pieces of wood may be treated simultaneously, with the first flow passing between the pieces.

The pieces of wood being i may be displaced horizontally from one another for allowing the first flow to pass approximately vertically between them. As the wood generally has a higher temperature than the treatment liquid, this will induce a vertical flow component of the treatment liquid between the pieces of wood. Additionally or alternatively, the pieces of wood may be displaced vertically from one another for allowing the first flow to pass approximately horizontally between them. This may be an advantage if a flow between the pieces of wood is required, but a vertical flow component through convection is to be avoided, which may give a higher control over the first flow.

The method for treating wood according to the first aspect of the present invention may further comprise the steps of providing a heat-exchanger for cooling the treatment liquid in the container, and employing the heat-exchanger for removing heat from the treatment liquid in the container. This may allow for a more, efficient cooling of the treatment liquid, which in turn may allow for a higher power in the radio-emission. As the temperature of the wood is determined by both the exposure to radio-emission and the temperature of the surrounding treatment liquid, the heat-exchanger allows for a better control of the temperature of the wood.

The method for treating wood according to the first aspect of the present invention may further comprise the steps of: providing a filter for removing particles expelled from the wood into the treatment liquid, and employing the filter to the treatment liquid in the container for removing at least some of the particles expelled from the wood. This means that the particles will be removed from the treatment liquid, whereby they cannot block the fluid passageways of the wood, which in turn increases the rate of impregnation of the treatment fluid into the wood.

The method for treating wood according to the first aspect of the present invention may further comprise the steps of: providing a separator for removing natural liquids expelled from the wood into the treatment liquid, and employing the separator to the treatment liquid in the container for removing at least some of the natural liquids expelled from the wood. By natural liquids is meant liquids present in the wood structure prior to treatment by the proposed method. The natural liquids may be liquids natural to the wood, such as water, resin, or sap, or artificial liquids earlier impregnated into the wood, such as a preservation fluid or seawater. For example the treatment liquid may be linseed oil and the natural liquid may be water.

The radio-emission having a frequency in the range of approximately 10 MHz to approximately 30 MHz. It appears that radio-emission in this frequency range is particularly suitable for dielectric heating of wood.

The treatment liquid at the wood may have a temperature in the range of approximately 10 degrees C. to approximately 35 degrees C., which may be actively monitored by a heat sensor immersed in the treatment liquid, such as thermocouple thermometer. Further, the method for treating wood according to the first aspect of the present invention may further comprise the step of: dividing the exposure by radio-emission into a plurality of sequential exposures by radio-emission from the electrode, the plurality of sequential exposures being separated in time for repeatedly increasing the temperature of the wood. This allows for the wood to be repeatedly heated and cooled, which may result in an increased impregnation of the treatment fluid into the structure of the wood without any significant deformations of the wood.

The method for treating wood according to the first aspect of the present invention may further comprise the step of limiting the time and power of each sequential exposure of the plurality of sequential exposures for preventing the temperature of the wood at least partially covered by the treatment liquid to exceed the temperature of the treatment liquid at the wood by at most approximately 50 degrees C. This way, significant deformations and structural damages of the wood are avoided. High temperatures could cause a phase transition in water contained in the wood from liquid to gaseous, which would drastically increase the internal pressure in the wood, if there are sharp variations in the internal pressure of the wood, this could cause it to crack.

The method for treating wood according to the first aspect of the present invention may further comprise the step of: providing a delay between a first exposure and a second exposure of the plurality of sequential exposures, the second exposure being subsequent to the first exposure, and the delay allowing the temperature of the wood at least partially covered by the treatment liquid to reach below a relaxation temperature after the first exposure and before the second exposure, the relaxation temperature may be approximately 10 degrees above the temperature of the treatment liquid at the wood. This allows for a repeated heating and cooling of the wood that for each cycle increases the contents of treatment liquid within the wood. Water may be used as treatment liquid for the purpose of removing salts or other water soluble substances within the wood. Naturally, the removal of salts requires the salt contents of the treatment liquid to be lower outside the wood than inside. The number of cycles in a treatment may be ten or more.

The temperature of the wood may be actively monitored by a heat sensor, such as thermocouple thermometer, attached to the wood, inserted between pieces of wood, or inserted into the structure of the wood. The latter may give the best measurement of the inner temperature of the wood. The temperature of the wood may also be indirectly determined, e.g. by that performing a standard treatment where the temperature of the wood is monitored and all parameters relevant for the temperature of the wood, such as radio-emission power, exposure time, relaxation time, specific volume, or first flow are determined. The parameters are then reused or repeated in subsequent treatments where wood of similar to that in the previous standard treatment, which means that the approximate desired temperature of the wood is achieved.

The objects, advantages and features are according to a second aspect of the present invention obtained by an apparatus for treating wood by a treatment liquid comprising: a container to hold the wood and the treatment liquid, an electrode positioned in the container to heat the wood by emitting radio-emission, a radio-frequency power-source to drive the electrode, a flow generator to provide a first flow of the treatment liquid towards and from the wood to exchange at least some of the treatment liquid at the wood. The wood, treatment fluid, container, and electrode may be the same as described above in relation to the first aspect of the present invention.

The flow generator may further comprise: an impeller positioned in the container to agitate the treatment liquid, and a motor to drive the impeller. This has the advantage of a simple technical realization, which means that it can be readily employed in situ, e.g. at the site where the trees are felled, to immediately produce impregnated lumber from the felled trees. This allows for rapid protection against microbes or insects attacking the wood. The impeller may be an axial flow impeller, such as a propeller on an axis, or a radial flow impeller, such as a paddle wheel on an axis. The motor may be an electric motor driving the impeller via the axis.

Additionally or alternatively, the flow generator may further comprise: an outlet to lead the treatment liquid from the container, an inlet to lead the treatment liquid to the container, a conduit interconnecting the outlet and aid inlet, and a pump to provide a circulating flow of the treatment liquid in the container out through the outlet and via the conduit back to the container through the inlet. Further, the outlet and/or the inlet may have an adjustable position relative to the container. Additionally or alternatively, the outlet and the inlet may be positioned at opposite sides of the wood. These features have the same advantages as the corresponding features described in relation to the first aspect of the present invention.

The apparatus according to the second aspect of the present invention may further comprise: a heat-exchanger to cool the treatment liquid in the container. Additionally or alternatively, the apparatus according to the second aspect of the present invention may further comprise: a separator to remove natural liquids expelled from the wood into the treatment liquid in the container. Further, the apparatus according to the second aspect of the present invention may further comprise: a filter to remove particles expelled from the wood into the treatment liquid. These features have the same advantages as the corresponding features described in relation to the first aspect of the present invention.

The radio-frequency power-source may further comprise: a delay circuit to provide a plurality of sequential exposures of the wood by radio-emission from the electrode, the plurality of sequential exposures being separated in time for repeatedly increasing the temperature of the wood. This allows for a repeated heating and cooling of the wood that for each cycle increases the contents of treatment liquid within the wood. Further, water may be used as treatment liquid for the purpose of removing salts or other water soluble substances within the wood

### BRIEF DESCRIPTION OF THE DRAWINGS

Additional objects and features according to the present invention will be more readily apparent from the following detailed description and from:

FIG. 1 illustrating an embodiment of the present invention, where the first flow is generated by an impeller,

FIG. 2 illustrating an alternative embodiment of the present invention, where the first flow is generated by a pump and the inlets and outlets have adjustable positions,

FIG. 3 illustrating another alternative embodiment of the of the present invention, where the wood comprises a plurality of pieces of wood,

FIG. 4 illustrating the same embodiment as in FIG. 3, but viewed from one of the short sides of the container,

FIG. 5 illustrating another alternative embodiment of the of the present invention,

FIG. 6a-e illustrating the sequential steps of a presently preferred embodiment of the proposed method for treating wood,

FIG. 7a-e illustrating the same sequential steps as in the corresponding FIG. 6a-e, but viewed from one of the short sides of the container.

### DETAILED DESCRIPTION OF THE INVENTION

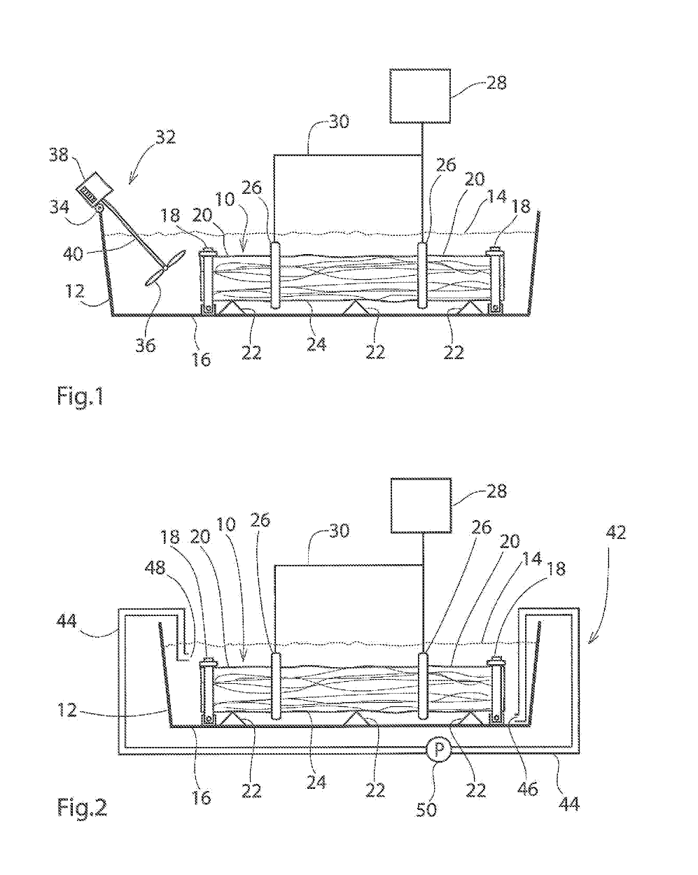

A sectional side view of a setup for treating wood according the present invention is outlined in FIG. 1. The wood in the form of a log 10 is located in a container 12 filled with a treatment liquid having a surface 14 located above the wood 10, thereby immersing the wood 10 completely in the treatment liquid. The treatment liquid is a preservative to prevent microbes from damaging the wood. The wood 10 is secured to the container 12 by straps 18 anchored to the bottom 16 of the container 12. The straps 18 engage only the top side 20 at either end of the log 10. This way, the straps will not hinder a flow of treatment liquid along the log 10. The wood 10 is held at a distance from the bottom 16 of the container 12 by spacers 22 located at the bottom 16 and having narrow engagement surfaces upon which the bottom side 24 of the wood 10 rests. With narrow engagement surfaces, a flow of treatment liquid along the length of the log 10 can reach most parts its bottom side 24.

Two of electrodes 26 are positioned along the length of the log 10. Each of the electrodes 26 is a flexible metal band with an electrically insulating coating, preventing short circuiting or resistive heating of the log 10. The electrodes 10 are bent to trace the outline of the log at a distance, thereby allowing t flow of treatment liquid between the electrodes 26 and the wood 10. The electrodes are connected to a radio-frequency power-source 28 via electrical conduits 30. When the radio-frequency power-source 28 is activated, the electrodes emit radio-emission or waves inducing dielectric heating of the wood 10.

An impeller 32 is attached to one end of the container 10 by a pivotal support 34, allowing it to be rotated into and out of the treatment liquid. The impeller constitutes a propeller 36 connected at its hub to an electrical motor 38 via an axis 40. When the electrical motor 38 is activated, the resulting rotation of the propeller 36 generates a first flow of treatment liquid towards, along, an away from the log 10.

A sectional side view of another setup for treating wood according the present invention is outlined in FIG. 2. Apart from the impeller 32 in FIG. 1, all the features of the setup in FIG. 2 has the corresponding feature in FIG. 1. Features with the corresponding function have been given the same number indexes in FIG. 1 and FIG. 2. The setup is further provided with a flow generator 42 including flexible tubing 44 having an inlet 46 and an outlet 48 below the surface 14 of the treatment liquid. Due to the flexible tubing 44, the positions of the inlet 46 and the outlet 48 are adjustable, and can be varied within the container 12. An electrically driven pump 50 provides a flow of the treatment liquid out through the outlet 48, through the flexible tubing 44, and back through the inlet 46. The inlet 46 and outlet 48 are positioned on opposite sides of the log 10, thereby generating a first flow of treatment liquid towards and from the log 10.

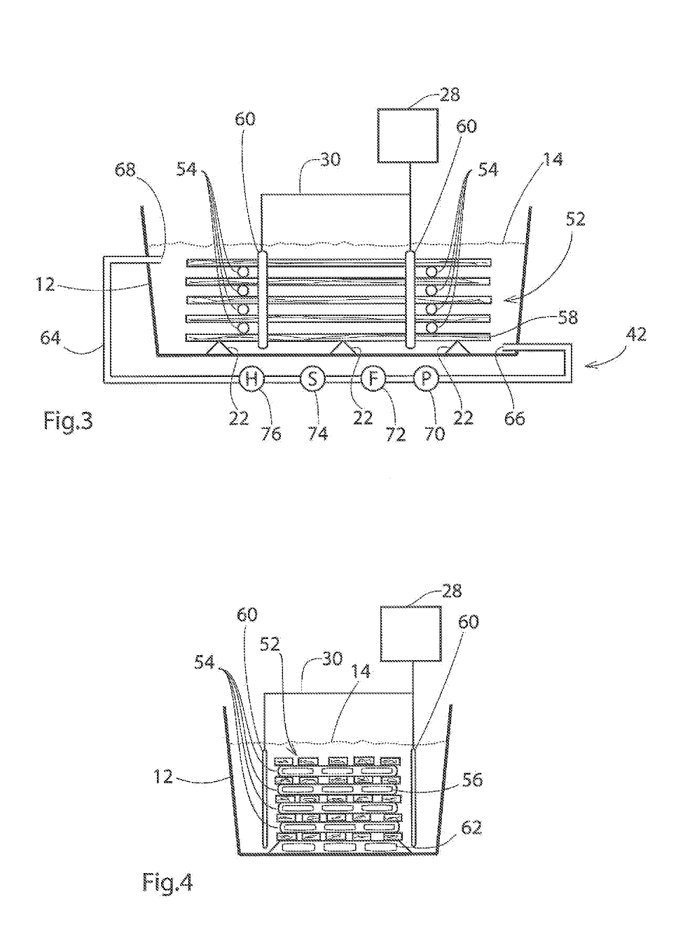

Another setup for treating wood according the present invention is outlined in FIG. 3 and FIG. 4, shown from different perspectives in the two figures. Features having the same functions as in FIG. 1 and FIG. 2 have been given the same index numbering in FIG. 3 and FIG. 4.

The wood in the form of boards 52 stacked in horizontal layers with board spacers 54 between each neighbouring pair of layers. The wood 52 is located in a container 12 filled with a treatment liquid having a surface 14 located above the wood 52, thereby immersing the wood 52 completely in the treatment liquid. The treatment liquid is a preservative to prevent microbes from damaging the wood.

The board spacers 54 allows for a flow of treatment liquid between two neighbouring layers. Further, the board spacers 54 are provided with through going holes 56, which reduce the flow resistance provided by the board spacers. The wood 10 is held at a distance from the bottom 16 of the container 12 by spacers 22 located at the bottom 16 and having narrow engagement surfaces upon which the bottom side 24 of the wood 10 rests. The spacers 22 are provided with through-going apertures 62 whereby, whereby the treatment liquid can readily flow between the lowest layer 58 of boards and the bottom 16 of the tank 12.

Four rod electrodes 60 are positioned vertically in the treatment liquid and distant from both the wood 52 and the walls of the container 12, allowing the treatment liquid to flow there between. Each of the electrodes 60 is a metal rod having an electrically insulating coating to prevent short-circuiting or resistive heating of the boards 52. The electrodes are connected to a radio-frequency power-source 28 via electrical conduits 30. When the radio-frequency power source 28 is activated, the electrodes emit radio-emission or waves inducing dielectric heating of the wood 52.

The setup is further provided with a flow generator 42 including rigid tubing 64 having an inlet 66 and an outlet 68 below the surface 14 of the treatment liquid, where the positions of the inlet 66 and the outlet 68 are fixed. An electrically driven pump 70 provides a flow of the treatment liquid out through the outlet 68, through the rigid tubing 64, and back through the inlet 66. The inlet 66 and outlet 68 are positioned on opposite sides of the tank 12, thereby generating a first flow of treatment liquid towards and from the boards 52.

The rigid tubing 64 leads the treatment liquid through a filter 72 removing particles expelled from the wood 52 into the treatment liquid. The filter comprises is a densely perforated plate allowing only particles under a certain size to pass. The filter 72 is placed upstream from the pump 70 so that the amount of particles entering the pump is reduced. The rigid tubing 64 also leads the treatment liquid through a separator 74 separating water expelled from the wood 52 and a heat exchanger 75 lowering the temperature of the treatment liquid.

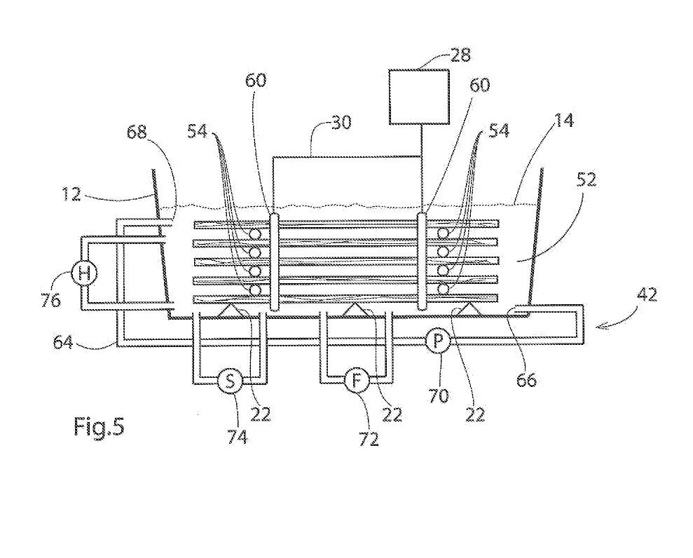

A sectional side view of another setup for treating wood according the present invention is outlined in FIG. 5. Apart from coupling of the filter 72, separator 74, and heat-exchanger 76 to the container 12, all the features of the setup in FIG. 3 and FIG. 4 has the corresponding feature in FIG. 1. Features with the corresponding function have been given the same number indexes in FIG. 3 to FIG. 5. The filter 72, separator 74, and heat-exchanger 76 are separately connected to the container 12 and are each provided with its own circulation pump for leading the treatment liquid from and back to the container 12.

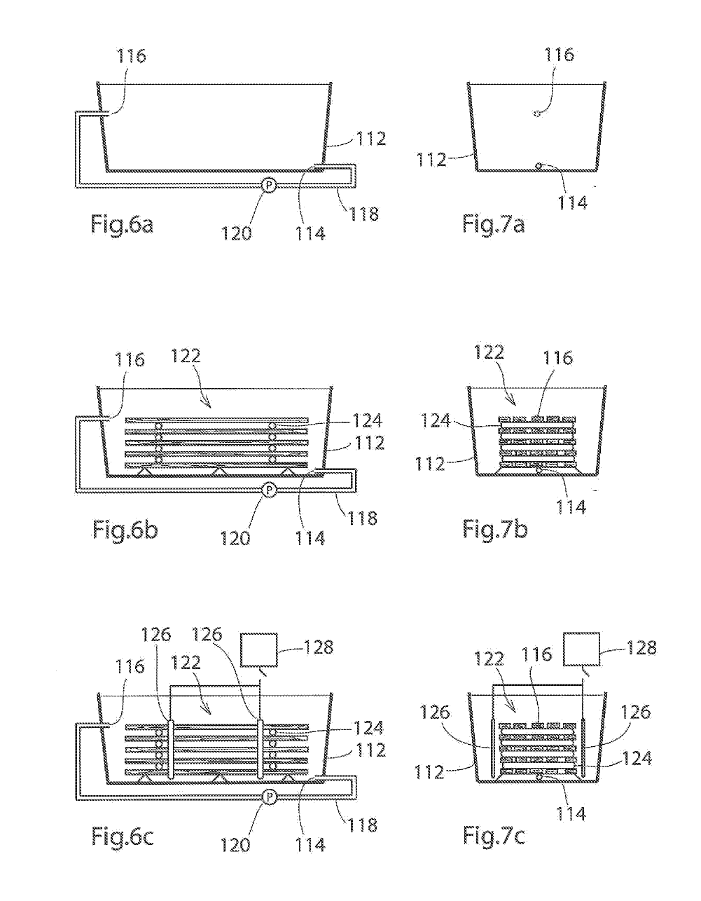

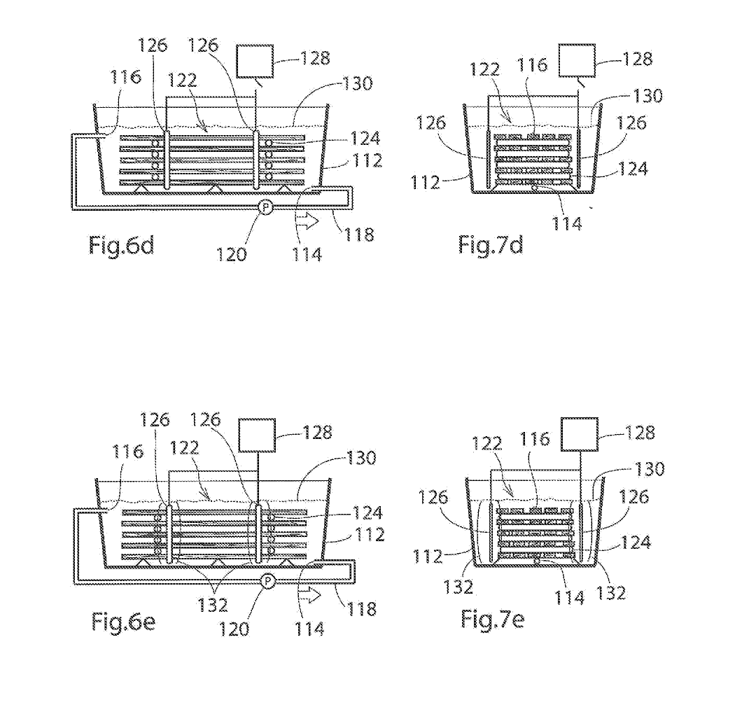

FIG. 6a-e illustrates the sequential steps of a presently preferred embodiment of the proposed method for treating wood. FIG. 7a-e illustrates the same sequential steps as in the corresponding FIG. 6a-e, but viewed from one of the short sides of the container 112. In FIG. 6a and FIG. 7a a container 112 is provided with an outlet 114 and an inlet 116, where the outlet 114 and the inlet 116 are interconnected by a conduit 118. The conduit in turn 118 is provided with a pump 120.

In FIG. 6b and FIG. 7b wood, in the form of boards 122 stacked in horizontal layers with board spacers 124 between each neighbouring pair of layers, is placed in the container 122. In FIG. 6c and FIG. 7c four rod electrodes 126 are positioned vertically and distant from both the wood 122 and the wails of the container 112. At the same time, a radio-frequency power-source 128 is provided. In FIG. 6d and FIG. 7d a specific volume of treatment liquid is provided in the container 112. The specific volume is sufficient for completely immersing the wood 122 and the electrodes 126 below the surface 130 of the treatment liquid. A first flow of the treatment liquid towards and from the wood 122 is provided by further activating the pump 120. Subsequently, in FIG. 6e and FIG. 7e the wood 122 is subjected to radio emission 132 from the electrodes 126 by activating the radio-frequency power-source 128.

### ITEM LIST

10 wood

12 container

14 surface treatment liquid

16 bottom of container

18 straps

20 top side of wood

22 spacers

24 bottom side

26 electrodes

28 radio-frequency power-source

30 electrical conduits

32 impeller

34 pivotal support

36 propeller

38 electrical motor

40 axis

42 flow generator

44 flexible tubing

46 inlet

48 outlet

50 pump

52 wooden boards

54 board spacers

56 through-going holes

58 lowest board layer

60 rod electrodes

62 through-going apertures

64 rigid tubing

66 inlet

68 outlet

70 pump

72 filter

74 separator

76 heat-exchanger

112 container

114 outlet

116 net

118 conduit

120 pump

122 wood

124 spacers

126 electrodes

128 radio-frequency power-source

130 surface of treatment liquid

132 radio emission

1. A method for treating wood by a treatment liquid comprising the steps of:
providing a container to hold said wood and said treatment liquid,
placing said wood in said container,
providing a electrode in said container for subjecting said wood to radio-emission,
providing a specific volume of said treatment liquid in said container for at least partially covering said wood and to at least partially covering said electrode below the surface of said treatment liquid,
providing a first flow in said container of said treatment liquid towards and from said wood at least partially covered by said treatment liquid for removing at least some of said treatment liquid at said wood, and
subjecting said wood at least partially covered by said treatment liquid to an exposure by radio-emission from said electrode for increasing the temperature of said wood.

2. The method for treating wood according to claim 1 characterized by said step of providing a first flow in said container further comprising:
providing an outlet for said treatment liquid in said container,
providing an inlet for said treatment liquid in said container,
interconnecting said outlet and said inlet for leading said treatment liquid there between,
providing a circulation flow of said treatment liquid in said container out through said outlet and via said conduit back to said container through said inlet.

3. The method for treating wood according to claim 2 characterized by said outlet and/or said inlet having an adjustable position relative to said container.

4. The method for treating wood according to claim 2 characterized by said step of providing a first flow in said container further comprising:
positioning said outlet and said inlet on opposite sides of said wood.

5. The method for treating wood according to claim 2 characterized by said step of providing a first flow in said container further comprising:
positioning said inlet at the bottom of said container.

6. The method for treating wood according to claim 1 characterized by further comprising the step of:
positioning said electrode distant from said wood for allowing said first flow to pass between said wood and said electrode.

7. The method for treating wood according to claim 1 characterized by said wood comprising a plurality of pieces of wood and said method further comprising the step of:
positioning said pieces of wood distant from one another for allowing said first flow to pass between them.

8. The method for treating wood according to claim 7 characterized by said pieces of wood being displaced horizontally from one another for allowing said first flow to pass approximately vertically between them.

9. The method for treating wood according to claim 7 characterized by said pieces of wood being displaced vertically from one another for allowing said first flow to pass approximately horizontally between them.

10. The method for treating wood according to claim 1 characterized by further comprising the steps of:
providing a heat-exchanger for cooling said treatment liquid in said container, and
employing said heat-exchanger for removing heat from said treatment liquid in said container.

11. The method for treating wood according to claim 1 characterized by further comprising the steps of:
providing a filter for removing particles expelled from said wood into said treatment liquid, and
employing said filter to said treatment liquid in said container for removing at least some of said particles expelled from said wood.

12. The method for treating wood according to claim 1 characterized by further comprising the steps of:
providing a separator for removing natural liquids expelled from said wood into said treatment liquid, and
employing said separator to said treatment liquid in said container for removing at least some of said natural liquids expelled from the wood.

13. The method for treating wood according to claim 1 characterized by said radio-emission having a frequency in the range of approximately 10 MHz to approximately 30 MHz.

14. The method for treating wood according to claim 1 characterized by said treatment liquid at said wood having a temperature in the range of approximately 5 degrees C. to approximately 40 degrees C.

15. The method for treating wood according to claim 1 characterized by further comprising the step of:
dividing said exposure by radio-emission into a plurality of sequential exposures by radio-emission from said electrode, said plurality of sequential exposures being separated in time for repeatedly increasing the temperature of said wood.

16. The method for treating wood according to claim 15 characterized by further comprising the step of:
limiting the time and power of each sequential exposure of said plurality of sequential exposures for preventing the temperature of the wood at least partially covered by said treatment liquid to exceed the temperature of the treatment liquid at said wood by at most approximately 50 degrees C.

17. The method for treating wood according to claim 15 characterized by further comprising the step of:
providing a delay between a first exposure and a second exposure of said plurality of sequential exposures, said second exposure being subsequent to said first exposure, and said delay allowing the temperature of the wood at least partially covered by said treatment liquid to reach below a relaxation temperature after said first exposure and before said second exposure, said relaxation temperature being approximately 10 degrees above the temperature of the treatment liquid at said wood.

18. An apparatus for treating wood by a treatment liquid comprising:
a container to hold said wood and said treatment liquid,
an electrode positioned in said container to heat said wood by emitting radio-emission,
a radio-frequency power-source to drive said electrode,
a flow generator to provide a first flow of said treatment liquid towards and from said wood to exchange at least some of said treatment liquid at said wood.

19. The apparatus according to claim 18 characterized by said flow generator further comprising:
an impeller positioned in said container to agitate said treatment liquid, and
a motor to drive said impeller.

20. The apparatus according to claim 18 characterized by said flow generator further comprising:
an outlet to lead said treatment liquid from said container,
an inlet to lead said treatment liquid to said container,
a conduit interconnecting said outlet and aid inlet, and
a pump to provide a circulating flow of said treatment liquid in said container out through said outlet and via said conduit back to said container through said inlet.

21. The apparatus according to claim 18 characterized by said outlet and/or said inlet having an adjustable position relative to said container.

22. The apparatus according to claim 18 characterized by said outlet and said inlet being positioned at opposite sides of said wood.

23. The apparatus according to claim 18 characterized by further comprising:
a heat-exchanger to cool said treatment liquid in said container.

24. The apparatus according to claim 18 characterized by further comprising:
a separator to remove natural liquids expelled from said wood into said treatment liquid in said container.

25. The apparatus according to claim 18 characterized by further comprising:
a filter to remove particles expelled from said wood into said treatment liquid.

26. The apparatus for treating wood according to claim 18 characterized by said a radio-frequency power-source further comprising:
a delay circuit to provide a plurality of sequential exposures of said wood by radio-emission from said electrode, said plurality of sequential exposures being separated in time for repeatedly increasing the temperature of said wood.
